(19) United States
(12) Patent Application Publication
(10) Pub. No.: US 2013/0149436 A1
(43) Pub. Date: Jun. 13, 2013

(54) PROCESS FOR PREPARING A SOLID STATE ELECTROLYTE USED IN AN ELECTROCHEMICAL CAPACITOR

(71) Applicant: National Kaohsiung University of Applied Sciences, Kaohsiung (TW)

(72) Inventors: Tar-Hwa HSIEH, Kaohsiung City (TW); Hung-Shiang CHEN, Tainan City (TW); Min-Hsun HSIEH, Burnaby (CA); Yi-Ming HUANG, Taichung City (TW)

(73) Assignee: NATIONAL KAOHSIUNG UNIVERSITY OF APPLIED SCIENCES, Kaohsiung (TW)

(21) Appl. No.: 13/683,900

(22) Filed: Nov. 21, 2012

(30) Foreign Application Priority Data
Dec. 7, 2011 (TW) 100145098

(51) Int. Cl. H01G 9/00

(52) U.S. Cl. CPC H01G 9/0036
USPC 427/80

(57) ABSTRACT

A process for preparing a solid state electrolyte used in an electrochemical capacitor includes the steps of: (a) preparing a prepolymer composition which includes a water-retaining polymer component and a film-forming hydroxyl-containing polymer component; (b) subjecting the prepolymer composition to a crosslinking reaction so as to form a polymer matrix membrane including a polymer matrix and an ion-permeable film; and (c) treating the polymer matrix membrane with an aqueous solution which includes a plurality of positive and negative ions so as to permit the positive and negative ions to permeate the ion-permeable film to be retained in the polymer matrix, thereby forming the solid state electrolyte.

### CROSS-REFERENCE TO RELATED APPLICATION

This application claims priority of Taiwanese application no. 100145098, filed on Dec. 7, 2011.

### BACKGROUND OF THE INVENTION

1. Field of the Invention

This invention relates to a process for preparing a solid state electrolyte used in an electrochemical capacitor.

2. Description of the Related Art

A conventional capacitor includes two electrodes separated by a dielectric (such as an air gap, paper, mica, glass, a plastic sheet, oil, etc). When a direct current passes through the capacitor, a potential difference (voltage) is generated between the electrodes and a static electric field develops across the dielectric, causing positive charge to collect on one of the electrodes and causing negative charge to collect on the other one of the electrodes, thereby storing energy in the capacitor. Although a capacitor can be charged and discharged rapidly, and has high power and a long service life, the energy density thereof is still insufficient. An ultracapacitor, also known as supercapacitor or electrochemical capacitor (EC), has a power density which is greater than 1 KW/kg, and which is more than 100 times higher than that of a normal secondary battery. Besides, the electrochemical capacitor has a capacitance of Farad-level, and an energy density which is several thousand to several ten thousand times greater than that of the conventional capacitor. Hence, many efforts have been devoted to developing a large-capacitance capacitor.

Electrochemical capacitors can be divided into electric double-layer capacitors (EDLCs) and pseudocapacitors based on their mechanisms. In the EDLC, positive and negative ions in an electrolyte are separated due to an electrostatic Coulomb force which is generated among the electrolyte and two electrodes, thereby forming the so-called “electric double layer” at an electrolyte-electrode interface and storing energy. The charge capacity of the EDLC is proportional to the potential differential between the two electrodes of the EDLC. In the pseudocapacitor, in addition to the formation of an “electric double layer,” a rapid reversible reaction (such as a Redox reaction or an electroadsorption/desorption reaction) occurs at the electrodes because the potential differential between the two electrodes falls within a range of a decomposition potential for the electrolyte, thereby further increasing the charge capacity. The pseudocapacitor involves a faradaic charge transfer, and thus is also known as a Faradic capacitor. In order to increase the capacitance of the electrochemical capacitor, the electrolyte preferably has a relatively low impedance (bulk ionic resistance). That is, the ionic conductively material in the electrolyte preferably has higher concentration and ionic conductivity. In general, an aqueous electrolyte or an organic solvent electrolyte is known as a liquid state electrolyte, whereas an electrolyte in a solid state is known as a solid state electrolyte. In some of the commercial electrochemical capacitors, the electrolytes are mainly composed of a sulfuric acid solution. However, such commercial electrochemical capacitors have poor stability at a temperature higher than 85° C. A decomposition potential for the sulfuric acid is about 1.2 volt. Thus, such commercial electrochemical capacitors have poor heat stability and are unsuitable for serving as a high-voltage device. Besides, the sulfuric acid solution is hard to be packaged and is likely to damage packaging materials and leak out of the electrochemical capacitors.

A solid state electrolyte plays the role of a separator for the electrodes, and should be provided with an ionic conductivity ranging from 10⁻⁴ S/cm to 10⁻³ S/cm. The solid state electrolytes can be sorted into the following three types: (a) gel-polymer electrolytes (GPEs), (b) composite polymer electrolytes (CPEs), and (c) solid polymer electrolytes (SPEs). In 1973, Wright et al. first reported a solid state electrolyte of crystalline composite which is made by mixing polyethylene oxide (PEO) with potassium thiocyanate (KSCN), and which has an ionic conductivity greater than 10⁻⁴ S/cm at a temperature greater than 60° C. Thereafter, much research have been focused on solid state electrolytes. For example, Chun-Chen Yang et al. proposed “All solid-state electric double-layer capacitors based on alkaline polyvinyl alcohol polymer electrolytes,” Journal of Power Sources 152 (2005) 303-310.

Generally, a polymer matrix membrane of polyvinyl alcohol (PVA) can be swelled by an aqueous solution to form a plurality of water channels therein. Thus, the swelled PVA membrane can serve as a solid state electrolyte with an increased ionic conductivity.

Shui-Fu Hsu, Shi-hao Ya, and Tar-Hwa Hsieh (joint inventor of the present invention, proposed “A research of electrical characteristics of a polyacrylic acid/polyvinyl alcohol composite film to serve as a solid state electrolyte of a ruthenium oxide electrochemical capacitor,” Journal of Industrial Technology Education (2010), vol. 7 (2), p 371-377. In this paper, two solid state electrolytes are disclosed. One of the solid state electrolytes was prepared by: (a) adding and mixing acrylic acid (AA) monomers and triallylamine (a crosslinking agent) in distilled water at 60° C. for 12 hours to obtain an AA solution, (b) adding a KOH solution including AA monomers at a concentration of 75 mole % into the AA solution, and adding a PVA solution (which was prepared by dissolving PVA in distilled water of 60° C.) into the AA solution, (c) mixing the AA solution until a homogeneous solution was obtained, (d) adding a solution including ammonium persulfate (initiator) and AA monomers at a concentration of 10 wt % into the homogeneous solution, followed by mixing at 90° C. for 2 hours such that the AA monomers were subjected to a free-radical polymerization/crosslinking reaction, (e) pouring the reacted solution over a flat glass member, and drying the same in a vacuum oven (80° C.) for 6 hours to obtain a PVA/PAA membrane, and (f) immersing the PVA/PAA membrane in a KOH solution (32 wt %) for 24 hours, thereby obtaining a KOH-based solid state electrolyte. The other one of the solid state electrolytes was prepared by (a) pouring a solution including PAA and PVA on a flat glass member and drying the same in a vacuum oven (80° C.) for 6 hours to obtain a PVA/PAA membrane, and (f) immersing the PVA/PAA membrane in a KOH solution (32 wt %) for 24 hours, thereby obtaining a KOH-based solid state electrolyte. However, the KOH-based solid state electrolyte has a relatively low ionic conductivity, and thus a KOH-based electrochemical capacitor made using the KOH-based solid state electrolyte has a relatively low capacitance.

### SUMMARY OF THE INVENTION

An object of the present invention is to provide a process for preparing a solid state electrolyte used in an electrochemical capacitor which can provide a higher capacitance compared to the aforesaid KOH-based electrochemical capacitors.

Accordingly, a process for preparing a solid state electrolyte used in an electrochemical capacitor having two electrodes includes the following steps of:

(a) preparing a prepolymer composition which includes a water-retaining polymer component and a film-forming hydroxyl-containing polymer component;

(b) subjecting the prepolymer composition to a crosslinking reaction in a first aqueous solution so as to form a polymer matrix membrane including a polymer matrix and an ion-permeable film which encloses the polymer matrix, and which has two major film surfaces for direct contact with the two electrodes, respectively; and

(c) treating the polymer matrix membrane with a second aqueous solution which includes an ionically conductive material that is dissociable into a plurality of positive and negative ions so as to permit the positive and negative ions in the second aqueous solution to permeate the ion-permeable film to be retained in the polymer matrix, thereby forming the solid state electrolyte.

Preferably, the film forming hydroxyl-containing polymer component includes polyvinyl alcohol which is subjected to the crosslinking reaction; the water-retaining polymer component includes polyacrylic acid; and the second aqueous solution is a sulfuric acid solution.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows a schematic view of the preferred embodiment of an electrochemical capacitor according to this invention;

FIG. 2 is a flow diagram illustrating the preferred embodiment of a process for preparing a solid state electrolyte used in the electrochemical capacitor according to this invention;

FIG. 3 shows Nyquist plots for an impedance measurement test in Experiment 1;

FIG. 4 shows a graph plotting liquid absorption ratio versus time, for a swelling property test in Experiment 1;

FIG. 5 shows a graph plotting swelling ratio versus time, for the swelling property test in Experiment 1;

FIG. 6 shows Nyquist plots for an impedance measurement test in Experiment 2;

FIG. 7 shows differential scanning calorimetry (DSC) thermographs for a thermal analysis test in Experiment 2;

FIG. 8 shows thermal gravimetric analysis (TGA) traces for the thermoanalysis test in Experiment 2;

FIG. 9 shows a graph plotting swelling ratio versus time, for a swelling property test in Experiment 2;

FIG. 10 shows cyclic voltammetry plots for a cyclic voltammetry test in Experiment 3;

FIG. 11 shows Nyquist plots for an impedance measurement test in Experiment 3;

FIG. 12 shows Nyquist plots for an impedance measurement test in Experiment 4;

FIG. 13 shows Bode plots constructed by plotting the logarithm of the magnitude of the impedance (Z′) versus the logarithm of frequency (f), for the impedance measurement test in Experiment 4;

FIG. 14 shows a device for determining decomposition potential of an electrolyte; and

FIG. 15 shows a graph plotting the current passing through each electrochemical capacitor versus the potential differential between the two electrodes of each electrochemical capacitor, for a linear sweep voltammetry test in Experiment 4.

### DETAILED DESCRIPTION OF THE PREFERRED EMBODIMENTS

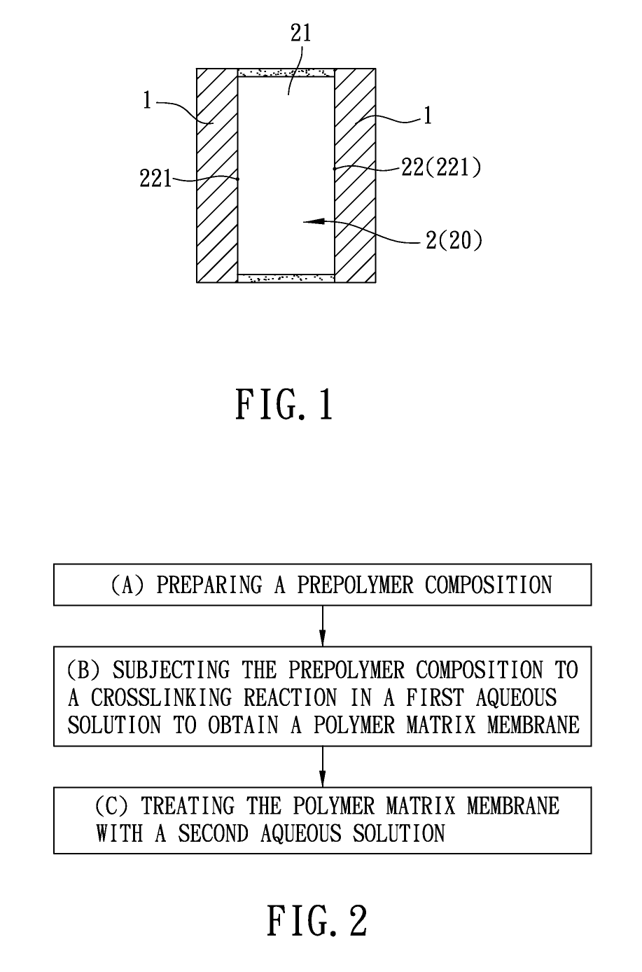

FIG. 1 shows the preferred embodiment of an electrochemical capacitor according to this invention, the electrochemical capacitor includes two spaced apart electrodes 1 and a solid state electrolyte 2 sandwiched between the electrodes 1.

The electrodes 1 are made of a material selected from metals or metal oxides which have a good electrical conductivity. Preferably, in order to provide pseudo-capacitance properties and to increase the available number of charge/discharge cycles, the electrodes 1 are preferably made of ruthenium oxide (RuO₂) or a ruthenium oxide hydrate compound (RuO₂.xH₂O). In the preferred embodiment, the electrodes 1 are made of ruthenium oxide.

Referring to FIG. 2, the preferred embodiment of a process for preparing the solid state electrolyte 2 includes the following steps (a) to (c).

In step (a), a prepolymer composition is prepared and is dispersed in a first aqueous solution. The prepolymer composition includes a water-retaining polymer component and a film-forming hydroxyl-containing polymer component. The water-retaining polymer component preferably has carboxyl groups for retaining an aqueous electrolyte solution therein. In the preferred embodiment, the water-retaining polymer component includes polyacrylic acid (PAA), and the film-forming hydroxyl-containing polymer component includes polyvinyl alcohol (PVA).

In step (b), the film-forming hydroxyl-containing polymer component in the prepolymer composition is subjected to a crosslinking reaction in the first aqueous solution so as to form a polymer matrix membrane 20. The polymer matrix membrane 20 includes a polymer matrix 21 and an ion-permeable film 22 which encloses the polymer matrix 21, and which has two major film surfaces 221 for direct contact with the two electrodes 1, respectively. In this step, excess water in the polymer matrix membrane 20 is evaporated by heating/drying.

The first aqueous solution is a diluted acid solution, for example, a diluted sulfuric acid solution, for catalyzing the crosslinking reaction. Preferably, the prepolymer composition is dissolved in the first aqueous solution, followed by adding a crosslinking agent which is capable of reacting with the hydroxyl groups of the film-forming hydroxyl-containing polymer component. The crosslinking agent may be glutaraldehyde, succindialdehyde, oxalaldehyde, or combinations thereof. In the presence of the crosslinking agent in the acid condition, the PVA is subjected to a crosslinking reaction. The PVA in the polymer matrix membrane 20 has a crosslinking degree ranging from 25% to 40%. In order to render the polymer matrix membrane 20 to have better size stability, heat stability, and ionic conductivity, the crosslinking degree of the PVA in the polymer matrix membrane 20 preferably ranges from 30% to 40%. Besides, because the PAA has a plurality of carboxyl groups for retaining water, the water-retaining and swelling properties of the polymer matrix membrane 20 would increase with the increased ratio of the PAA. However, the swelling property is adverse to the size stability of the polymer matrix membrane 20, and thus, the PAA is preferably in an amount ranging from 10 wt % to 47 wt % based on the total weight of the polymer matrix membrane 20.

In step (c), the polymer matrix membrane 20 is treated with a second aqueous solution which includes an ionically conductive material that is dissociable into a plurality of positive and negative ions so as to permit the positive and negative ions to permeate the ion-permeable film 22 to be retained in the polymer matrix 21, thereby forming the solid state electrolyte 2. In the preferred embodiment, the polymer matrix membrane 20 is treated with the second aqueous solution for at least 20 hours. The ionically conductive material in the second aqueous solution is sulfuric acid which has a concentration ranging from 1.0M to 3.0M. In consideration of the stability of the polymer matrix membrane 20, the concentration of the sulfuric acid in the second aqueous solution preferably ranges from 1.0M to 2.5M. Because the crosslinked polymer matrix membrane 20 made according to the process of this invention can resist the sulfuric acid solution so as to form the solid state electrolyte 2 with higher ionic conductivity, the electrochemical capacitor made using the solid state electrolyte 2 of this invention can have a higher capacitance compared to the KOH-based electrochemical capacitor of the prior art.

The present invention is explained in more detail below by way of the following examples and comparative examples.

### Experiment 1

### Comparative Example 1 (CE 1)

PVA (polyvinyl alcohol, Mw=89000˜98000, Tm=200° C., manufactured by Shimakyu's Pure Chemical) was mixed with a water solution at a temperature of 80° C. for 1 hour so as to fully dissolve the PVA to obtain a PVA solution in which the PVA was in an amount of 10 wt %. Then, the PVA solution was stirred at a temperature of 120° C. for 2 hours, followed by cooling to room temperature and drying in a vacuum oven at 40° C. for 12 hours to remove excess water, thereby obtaining a polymer matrix membrane which is a pure PVA membrane.

### Examples 1˜5

PVA was mixed with a water solution at a temperature of 80° C. for 1 hour so as to fully dissolve the PVA to obtain a PVA solution in which the PVA was in an amount of 10 wt %. Then, PAA (polyacrylic acid, Mw=25000, manufactured by Wako Pure Chemical Industries) was mixed with the PVA solution at a temperature of 120° C. for 2 hours, followed by cooling to room temperature and drying in a vacuum oven at 40° C. for 12 hours to remove excess water, thereby obtaining a polymer matrix membrane which is a PAA/PVA membrane. In Examples 1˜5, PAA was added in amounts of 9 wt %, 23 wt %, 33 wt %, 41 wt %, and 47 wt %, respectively, based on the total weight of the polymer matrix membranes.

Impedance Measurement Test

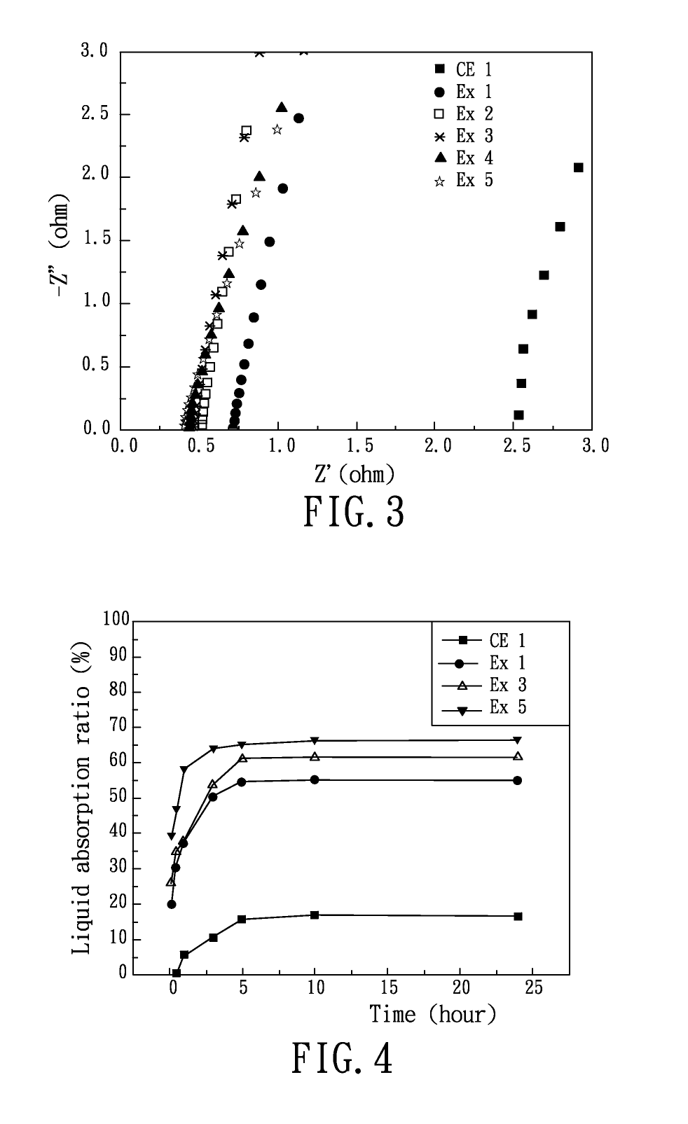

Each polymer matrix membrane obtained in one of Comparative Example 1 and Examples 1 to 5 was sandwiched between two electrodes made of stainless steel, and was then connected to a potentiostat/galvanostat (PGSTAT 30, Autolab, Eco-Chemie, Netherland) for measuring an impedance of the polymer matrix membrane using an alternating current method. During the measurement, the potentiostat/galvanostat was controlled to apply a frequency ranging from 50 Hz to 10⁵ Hz with an oscillation amplitude of 100 mV to each polymer matrix membrane. The result for each polymer matrix membrane was shown in the Nyquist plots of FIG. 3. The bulk ionic resistance (R_{b}) of each polymer matrix membrane was observed from the Nyquist plots shown in FIG. 3, and is listed in the following Table 1.

The ionic conductivity (σ) for each polymer matrix membrane was calculated based on the following equation (I) and is also listed in Table 1:

R_{b}=L/(A·σ) (I)

wherein A represents an area of each electrode which is in contact with the polymer matrix membrane, and σ represents a distance between the two electrodes (i.e., thickness of the polymer matrix membrane).

TABLE 1

| | PAA | Bulk ionic | Membrane | Ionic |
|---|---|---|---|---|
| | content | resistance | thickness | conductivity |
| membrane | (wt %) | (R_{b}, ohm) | (L, mm) | (σ, S/cm) |
| CE 1 | 0 | 2.5435 | 0.21 | 2.63 × 10⁻³ |
| Ex 1 | 9 | 0.7185 | 0.20 | 8.91 × 10⁻³ |
| Ex 2 | 23 | 0.5224 | 0.23 | 1.40 × 10⁻² |
| Ex 3 | 33 | 0.4738 | 0.22 | 1.48 × 10⁻² |
| Ex 4 | 41 | 0.4198 | 0.22 | 1.67 × 10⁻² |
| Ex 5 | 47 | 0.3953 | 0.23 | 1.85 × 10⁻² |

It is found that the polymer matrix membrane of Comparative Example 1, which is a pure PVA film with a semi-crystalline phase, has a relatively high bulk ionic resistance value. The polymer matrix membranes (PAA/PVA membranes) of Examples 1 to 5 have relatively low bulk ionic resistance values. It is speculated that with the increased weight percent of the PAA in the polymer matrix membrane, the phase of the polymer matrix membrane gradually changes from the semi-crystalline phase to an amorphous phase. The molecular chains in the amorphous phase structures are more flexible than those in a regularly arranged crystalline phase structure, and thus, ionic transfer in the PAA/PVA membranes is enhanced.

Swelling Property Test

Four samples of the polymer matrix membranes obtained respectively in Comparative Example 1 and Examples 1, 3 and 5 were prepared. Each polymer matrix membrane was treated using a sulfuric acid solution (1M), and its weight was measured before the treatment and after being treated for 10 minutes, 20 minutes, 30 minutes, 1 hour, 3 hours, 5 hours, 10 hours, 24 hours, respectively. The liquid absorption ratio and the swelling ratio for each polymer matrix membrane were calculated based on the following equations (II) and (III), respectively:

Liquid absorption ratio=(W₁−W₀)/W₁×100% (II)

Swelling ratio=(W₁−W₀)/W₀×100% (III)

where W₀ is the weight of the polymer matrix membrane before the treatment, and W₁ is the weight of the polymer matrix membrane after the treatment.

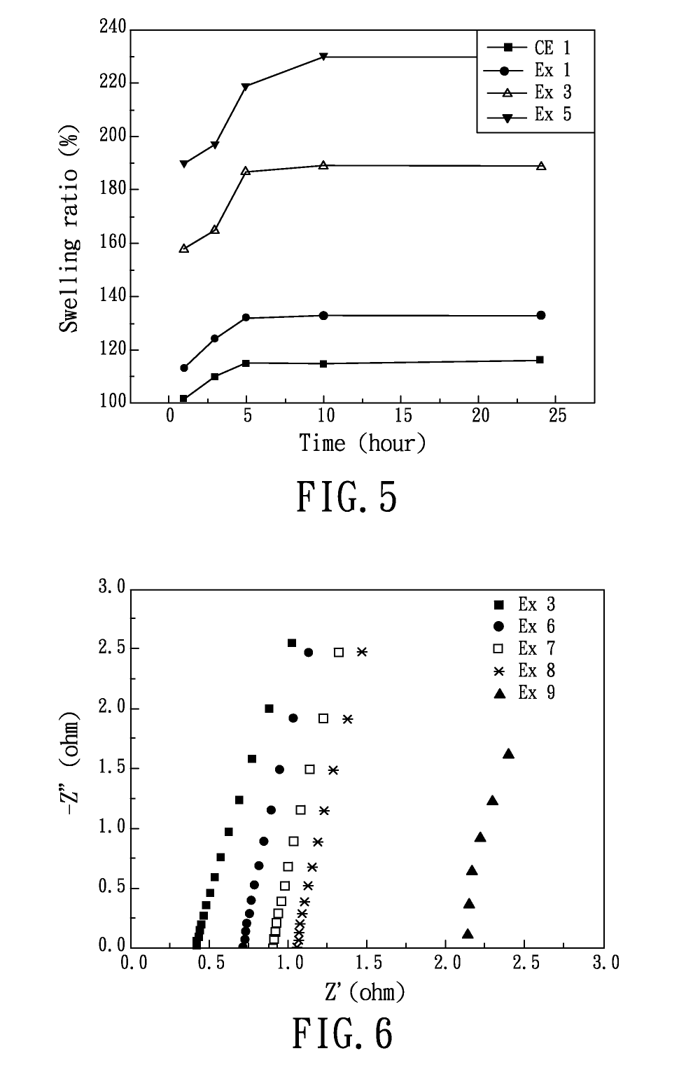

FIG. 4 shows a graph plotting liquid absorption ratio versus time, and FIG. 5 shows a graph plotting swelling ratio versus time. From the results shown in FIGS. 4 and 5, the liquid absorption ratio and the swelling ratio increase with the increased weight percent of the PAA in the polymer matrix membrane. This means the polymer matrix membrane with the PAA would have higher ionic conductivity but have lower size stability.

### Experiment 2

### Examples 6˜9

PVA was mixed with a diluted sulfuric acid solution at a temperature of 80° C. for 1 hour so as to fully dissolve the PVA to obtain a PVA acid solution in which the PVA was in an amount of 10 wt %. Then, PAA was mixed with the PVA acid solution at a temperature of 120° C. for 2 hours to obtain an acid-based PVA/PAA mixed solution. A predetermined amount of a glutaraldehyde aqueous solution in which the concentration of glutaraldehyde was 25 wt % was further added and mixed with the acid-based PVA/PAA mixed solution for another 2 hours, followed by cooling to room temperature and drying in a vacuum oven at 40° C. for 12 hours to remove excess water, thereby obtaining a polymer matrix membrane which is a PAA/PVA membrane. The PAA was added in each of Examples 6˜9 in an amount of 33 wt % based on the total weight of the polymer matrix membrane. In Examples 6˜9, the added amounts of the glutaraldehyde aqueous solution were 25 μl, 50 μl, 75 μl and 100 μl, respectively.

Crosslinking Degree

Five samples of the polymer matrix membranes obtained respectively in Examples 3 and 6˜9 were prepared. Each polymer matrix membrane was weighed using a scale to obtain an initial weight (W₀), and was then immersed in a water bath of 85° C. for 24 hours, dried and further weighed using the scale to obtain a residual weight (W₂). The crosslinking degree for each polymer matrix membrane was determined by the following equation (IV), and is listed in the following Table 2.

Crosslinking degree=(W₂/W₀)×100% (IV)

Relative Crystallinity

Five samples of the polymer matrix membranes obtained respectively in Examples 3 and 6˜9 were prepared. X-ray diffraction analyses for the five samples were performed using a X-Ray diffractometer (PANalytical, X'Pert Pro) with Cu-K1 radiation (λ=0.5402 Å). The scanning angle (20) was from 5° to 50°, and the scanning rate was set at 1°/min. The X-ray diffraction peak area of Example 3 was calculated to serve as a baseline, and thus the polymer matrix membrane of Example 3 was assumed to have a crystallinity of 100%. The X-ray diffraction peak areas of Examples 6˜9 were calculated and compared with the baseline, thereby obtaining the relative crystallinities of the polymer matrix membranes of Examples 6˜9, respectively, which are also listed in Table 2.

TABLE 2

| | Relative | Crosslinking |
|---|---|---|
| Membrane | Crystallinity (%) | degree (%) |
| Ex 3 | 100% | 0 |
| Ex 6 | 64.33 | 24.9 |
| Ex 7 | 51.71 | 31.8 |
| Ex 8 | 49.59 | 37.8 |
| Ex 9 | 44.74 | 40.3 |

* The polymer matrix membrane of Example 3 was formed without adding a crosslinking agent (the glutaraldehyde aqueous solution), and the PAA weight percents of the polymer matrix membranes in Examples 6~9 are the same as that of Example 3.

Impedance Measurement Test

Five samples of the polymer matrix membranes obtained respectively in Examples 3 and 6˜9 were prepared and were subjected to an impedance measurement test substantially the same as that in Experiment 1, and the results are shown in FIG. 6. The bulk ionic resistance (R_{b}) of each polymer matrix membrane was observed from the Nyquist plots shown in FIG. 6, and is listed in the following Table 3. The ionic conductivity (σ) for each polymer matrix membrane was calculated based on the above equation (I) and is also listed in Table 3.

TABLE 3

| | | Bulk ionic | Membrane | Ionic |
|---|---|---|---|---|
| | Crosslinking | resistance | thickness | conductivity |
| | degree (%) | (R_{b}, ohm) | (L, mm) | (σ, S/cm) |
| Ex 3 | 0 | 0.4218 | 0.21 | 1.58 × 10⁻² |
| Ex 6 | 24.9 | 0.7183 | 0.20 | 8.87 × 10⁻³ |
| Ex 7 | 31.8 | 0.9049 | 0.21 | 7.39 × 10⁻³ |
| Ex 8 | 37.8 | 1.0535 | 0.21 | 6.05 × 10⁻³ |
| Ex 9 | 40.3 | 2.1297 | 0.20 | 2.99 × 10⁻³ |

From the results shown in Table 3, it is found that when the PAA weight percents of the polymer matrix membranes are substantially the same (33 wt %), with the increase in the crosslinking degree, the bulk ionic resistance increases and the ionic conductivity decreases.

Thermal Analysis

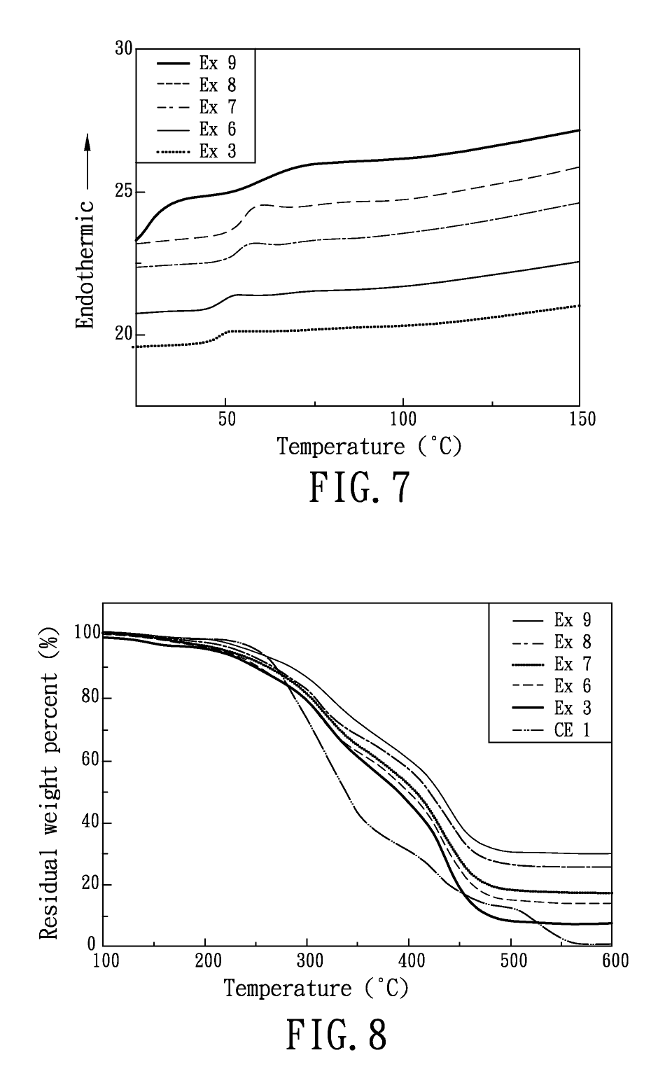

Five samples of the polymer matrix membranes obtained respectively in Examples 3 and 6˜9 were prepared and were subjected to thermal analysis using a differential scanning calorimeter (DSC, JADE DSC, PerkinElmer). The DSC was performed under nitrogen gas and was set to scan from 20° C. to 250° C. at a heating rate of 10° C./min. FIG. 7 shows the DSC analysis result.

From the DSC analysis result, it is found that the glass transition temperatures for the polymer matrix membranes of Examples 3 and 6˜9 are 48° C., 49° C., 54° C., 55° C., and 62° C., respectively. The crosslinking reaction will cause the flexible molecular chains in the polymer matrix membrane to be more rigid, and thus, the glass transition temperature of the polymer matrix membrane increases with the increase in the crosslinking degree.

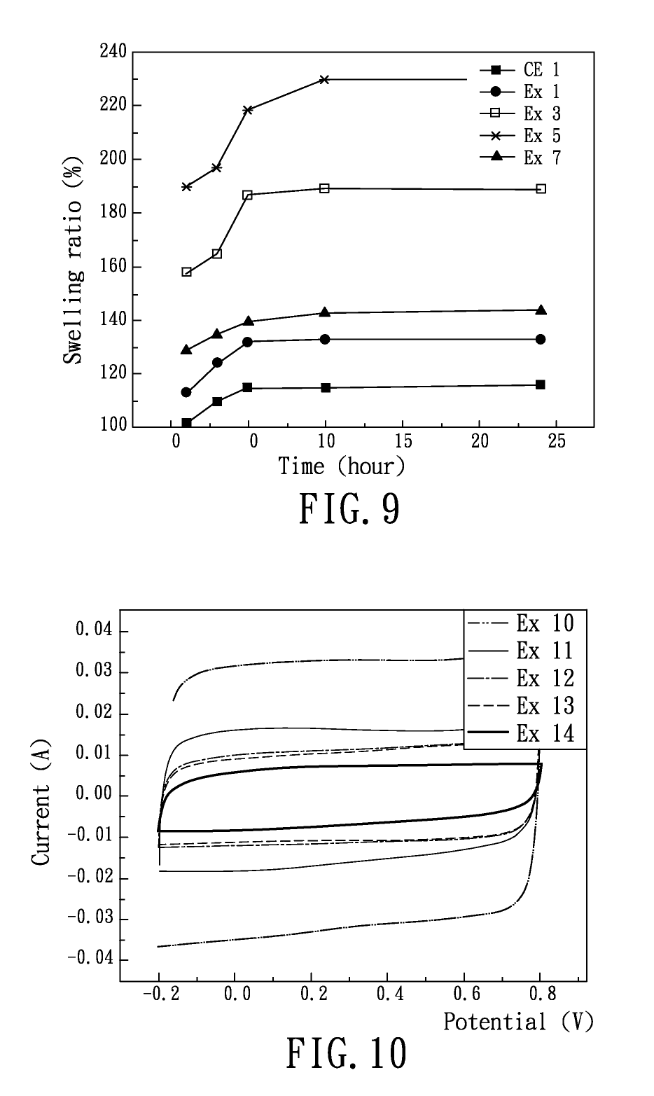

Five samples of the polymer matrix membranes obtained respectively in Examples 3 and 6˜9 were prepared and were subjected to thermoanalysis using a thermogravimetric analysis instrument (TGA, SDT-Q600, TA Instruments Inc.) The TGA was performed under nitrogen gas and was set to scan from 100° C. to 650° C. at a heating rate of 10° C./min. FIG. 8 shows the TGA analysis result.

From the TGA analysis result, it is found that all of the polymer matrix membranes started to decompose at a temperature about 200° C., and the pure PVA membrane (Comparative Example 1) was fully decomposed at a temperature about 570° C. Referring to the analysis curves of Examples 1 and 3 shown in FIG. 8, the residual weight percent of the polymer matrix membrane of Example (PAA/PVA membrane,) is greater than that of Comparative Example 1 (pure PVA membrane) at 570° C. In addition, the residual weight percent of the polymer matrix membrane increases with an increase in the crosslinking degree of the polymer matrix membrane (see the TGA analysis results for Examples 3 and 6˜9). Thus, the polymer matrix membrane having a greater crosslinking degree should have better heat stability.

Swelling Property Test

A sample of the polymer matrix membrane obtained in Example 7 was subjected to a swelling property test which is substantially the same as that in Experiment 1. The swelling ratio of Example 7 (Experiment 2) and the swelling ratios of Comparative Example 1 and Examples 1, 3 and 5 (Experiment 1, which is also shown in FIG. 5) are shown together in FIG. 9. It should be noted that the polymer matrix membranes of Examples 3 and 7 have the same PAA weight percent. The polymer matrix membrane of Example 3 was formed without adding the crosslinking agent which was added for preparing the membrane of Example 7. From the result shown in FIG. 9, it is found that the crosslinking reaction is helpful for reducing the swelling ratio of the polymer matrix membrane.

### Experiment 3

### Examples 10˜14

In Examples 10˜14, electrochemical capacitors were prepared using five samples of the polymer matrix membranes obtained in Example 3 and 6˜9, respectively. Each polymer matrix membrane was immersed in a sulfuric acid solution of 1.0M for 24 hours to obtain a solid state electrolyte. Two electrodes (i.e., anode and cathode electrodes) for each electrochemical capacitor were made of ruthenium oxide (RuO₂), and each was surrounded by a polyimide (PI) frame. When forming each electrochemical capacitor, the solid state electrolyte was screen-printed on an area of one of the electrodes surrounded by the PI frame, and then the other one of the electrodes was disposed on the solid state electrolyte such that the PI frames of the two electrodes were registered with each other. Finally, the two electrodes were subjected to a heat pressing process at 100° C. such that the solid state electrolyte was sealed between the electrodes, thereby obtaining the electrochemical capacitor.

Cyclic Voltammetry Test

The electrochemical capacitors of Examples 10˜14 were subjected to a cyclic voltammetry test using a potentiostat/galvanostat (PGSTAT 30, Autolab, Eco-Chemie, Netherland) at a scan rate of 100 mV/sec, and a potential window ranging from −0.2V to 0.8V at a temperature of 25° C. The cyclic voltammetry test was performed for testing the stability and reversibility of the electrochemical capacitors, and the results are shown in FIG. 10.

It can be seen from the cyclic voltammetry results in FIG. 10 that no apparent redox peak could be found in each cyclic voltammogram. This means that all of the electrochemical capacitors are rechargeable and are stable during their charge-discharge cycles. Besides, because each cyclic voltammogram is of a standard rectangular shape which is indicative of the properties of the ruthenium oxide electrodes, the electrochemical capacitors could be smoothly rechargeable.

Although the polymer matrix membrane with crosslinked PVA therein may have better size stability, its ionic conductivity decreases with an increase in the crosslinking degree of the polymer matrix membrane, which is adverse to the ion transfer in the polymer matrix membrane. Thus, it can be found in FIG. 10 that the area of the rectangular shape, which corresponds to the capacitance of the electrochemical capacitor, was reduced with the increase in the crosslinking degree.

In order to enhance the capacitance of the electrochemical capacitor, the polymer matrix membranes obtained in Examples 6˜9 were allowed to absorb a sulfuric acid solution with concentrations of 1.5M, 2.0M, and 2.5M, respectively. It is found that the polymer matrix membrane of Example 6 (crosslinking degree: 24.9%) was dissolved in a sulfuric acid solution of 1.5M, and the polymer matrix membrane of Example 7 (crosslinking degree: 31.8) was resistant to a sulfuric acid solution of 2.5M.

### Examples 15˜18

In Examples 15˜18, four samples of the polymer matrix membrane prepared according to Example 7 were immersed in sulfuric acid solutions of 1.0M, 1.5M, 2.0M and 2.5M, respectively, for 24 hours, so as to obtain respective solid state electrolytes.

Impedance Measurement Test

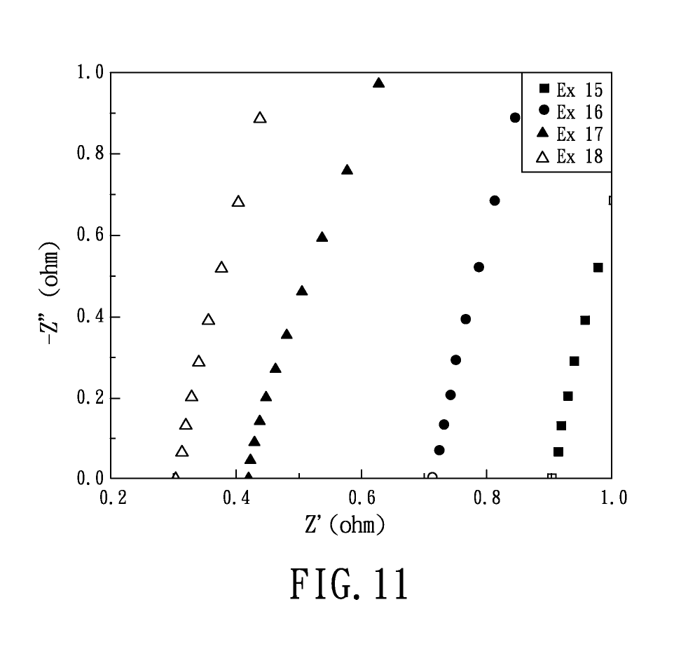

The solid state electrolytes of Examples 15˜18 were subjected to an impedance measurement test which is substantially the same as that in Experiment 1, and the results are shown in FIG. 11. The bulk ionic resistance (R_{b}) of each polymer matrix membrane was observed from the Nyquist plots shown in FIG. 11, and is listed in the following Table 4. The ionic conductivity (σ) for each polymer matrix membrane was calculated based on the aforesaid equation (I) and is also listed in Table 4.

TABLE 4

| | Sulfuric | Bulk ionic | Membrane | Ionic |
|---|---|---|---|---|
| | acid | resistance | thickness | conductivity |
| | solution (M) | (R_{b}, ohm) | (L, mm) | (σ, S/cm) |
| Ex 15 | 1.0 | 0.9072 | 0.20 | 7.02 × 10⁻³ |
| Ex 16 | 1.5 | 0.7118 | 0.20 | 8.95 × 10⁻³ |
| Ex 17 | 2.0 | 0.4186 | 0.21 | 1.59 × 10⁻² |
| Ex 18 | 2.5 | 0.3001 | 0.20 | 2.12 × 10⁻² |

It is noted from Table 2 that, with the increased concentration of the sulfuric acid solution, the bulk ionic resistance of the solid state electrolyte is reduced and the ionic conductivity is enhanced. The solid state electrolyte of Example 18 has the best ionic conductivity and it may also have good size stability (i.e., swelling ratio).

### Experiment 4

### Example 19

A sample of the solid state electrolyte obtained in Example 18 was prepared, and was sealed between two electrodes made of ruthenium oxide using a packaging method according to Example 10 so as to obtain an electrochemical capacitor.

### Comparative Example 2 (CE 2)

A commercial electrochemical capacitor (UT4001, Ultra-cap Technology co., Taiwan) was used to serve as Comparative Example 2, in which a sulfuric acid solution was used as an electrolyte, and two electrodes of the electrochemical capacitor were made of ruthenium oxide (RuO₂).

Impedance Measurement Test

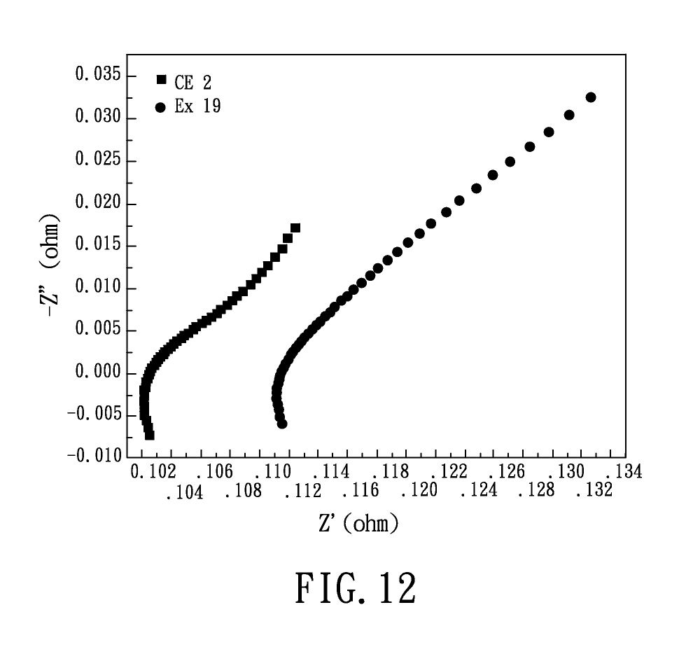

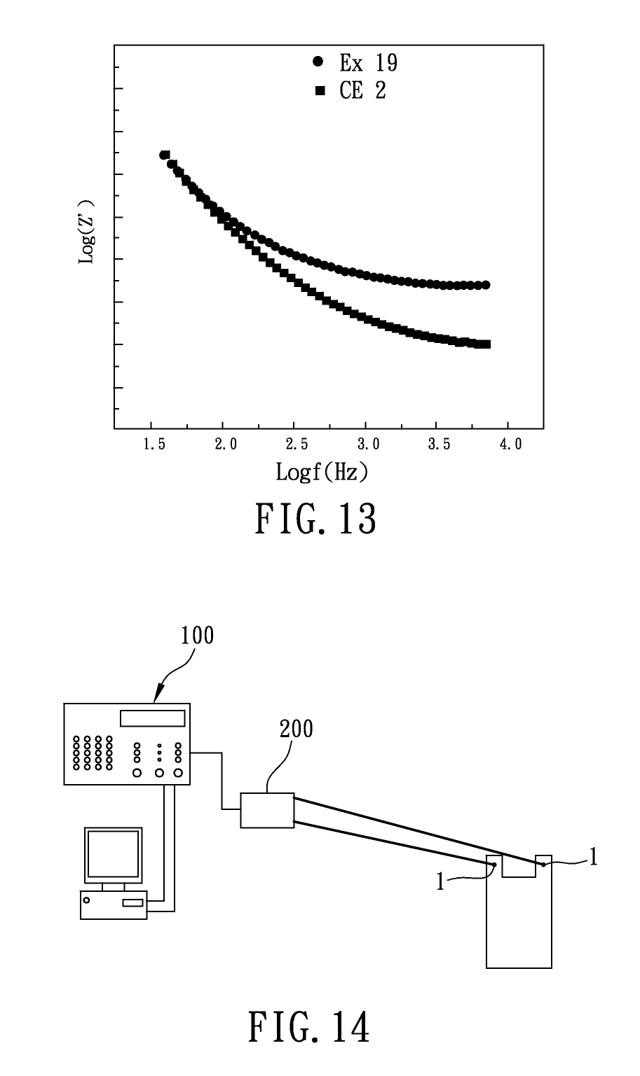

The electrochemical capacitors of Example 19 and Comparative Example 2 were subjected to an impedance measurement test which is substantially the same as that in Experiment 1, and the results are shown in FIGS. 12 and 13. FIG. 12 shows Nyquist plots for Example 19 and Comparative Example 2. FIG. 13 shows Bode plots for Example 19 and Comparative Example 2. Each Bode plot is constructed by plotting the logarithm of the magnitude of impedance (Z′) versus the logarithm of frequency (f).

It can be seen from the results shown in FIG. 12 that the bulk ionic resistance of Comparative Example 2 is 0.102 ohm, and the bulk ionic resistance of Example 19 is 0.113 ohm, which reaches the standard of commercial products.

It can be further seen from the results shown in FIG. 13 that in a high frequency zone (e.g., log(f)>3.0), the impedance (log(Z′)) of Comparative Example 2 is reduced to a higher extent than that of Example 19. This means that in comparison with the commercial electrochemical capacitor of Comparative Example 2, the electrochemical capacitor of Example 19 is more suitable to be applied to a high-frequency element.

Linear Sweep Voltammetry

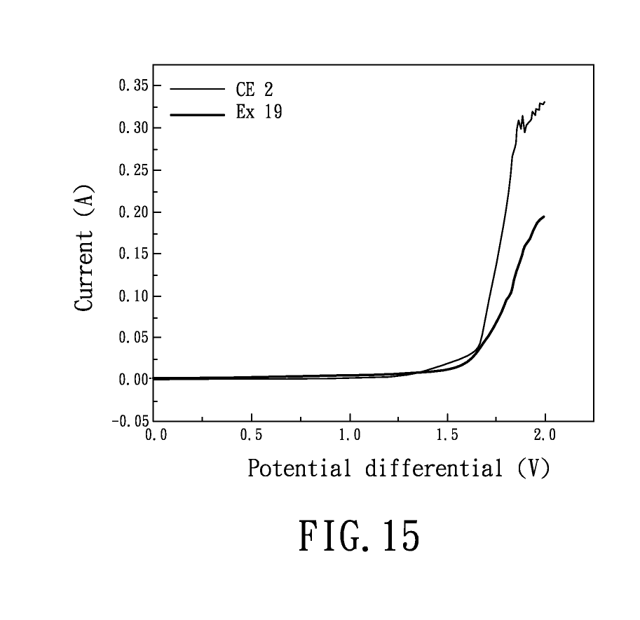

The electrochemical capacitors of Example 19 and Comparative Example 2 were prepared. Two electrodes 1 of each electrochemical capacitor were electrically connected to a potentiostat/galvanostat 100 through an electrometer 200 for measuring decomposition potentials using a linear sweep voltammetry method (see FIG. 14). Decomposition potential is the minimum voltage required for continuous electrolysis of an electrolyte. FIG. 15 shows a graph plotting a current passing through each of the electrochemical capacitors versus the potential differential between the two electrodes, while the potential differential of each of the electrochemical capacitors was swept linearly in time. It can be seen from the results shown in FIG. 15 that the decomposition potential of the commercial electrochemical capacitor (Comparative Example 2) is 1.3V, and the decomposition potential of the electrochemical capacitor according to the invention (Example 19) is 1.6V, which is higher than that of the Comparative Example 2. This means that under a potential differential of 1.3V, electrolysis reaction occurred in the commercial electrochemical capacitor, resulting in the generation of hydrogen and oxygen gases, and no electrolysis reaction occurred in the electrochemical capacitor of Example 19. It is speculated that because the polymer matrix membrane of the electrochemical capacitor of Example 19 has a plurality of the hydroxyl and carboxyl groups, the sulfuric acid solution in the polymer matrix membrane can be retained. Besides, when the potential differential approached 1.9V, the curve of Comparative Example 2 is in a sawtooth form, indicating possible explosion and deterioration, but no sawtooth is observed in the curve of Example 19. Therefore, the electrochemical capacitor of this invention is more stable than the commercial product of Comparative Example 2 when a relatively high voltage is applied thereto.

With the solid state electrolyte prepared according to the process of this invention, the acid solution (especially the sulfuric acid solution) is less likely to leak out of the electrochemical capacitor. Compared with commercial electrochemical capacitors, the electrochemical capacitor including the solid state electrolyte of this invention may be operated at a relatively high working voltage, a relatively high frequency and a relatively high temperature.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A process for preparing a solid state electrolyte used in an electrochemical capacitor that includes two electrodes, the process comprising the following steps of:
(a) preparing a prepolymer composition which includes a water-retaining polymer component and a film-forming hydroxyl-containing polymer component;
(b) subjecting the prepolymer composition to a crosslinking reaction in a first aqueous solution so as to form a polymer matrix membrane including a polymer matrix and an ion-permeable film which encloses the polymer matrix, and which has two major film surfaces for direct contact with the two electrodes, respectively; and
(c) treating the polymer matrix membrane with a second aqueous solution which includes an ionically conductive material that is dissociable into a plurality of positive and negative ions so as to permit the positive and negative ions to permeate the ion-permeable film to be retained in the polymer matrix, thereby forming the solid state electrolyte.

2. The process of claim 1, wherein the film forming hydroxyl-containing polymer component is subjected to the crosslinking reaction.

3. The process of claim 2, wherein the film-forming hydroxyl-containing polymer component includes polyvinyl alcohol.

4. The process of claim 3, wherein the water-retaining polymer component includes polyacrylic acid.

5. The process of claim 3, wherein the crosslinking reaction is implemented in presence of a crosslinking agent selected from the group consisting of glutaraldehyde, succindialdehyde, oxalaldehyde, and combinations thereof.

6. The process of claim 4, wherein the polyacrylic acid is in an amount ranging from 10 wt % to 47 wt % based on the total weight of the polymer matrix membrane.

7. The process of claim 4, wherein the polyvinyl alcohol in the polymer matrix membrane has a crosslinking degree ranging from 25% to 40%.

8. The process of claim 4, wherein the polymer matrix membrane is treated with the second aqueous solution for at least 20 hours.

9. The process of claim 8, the ionically conductive material is sulfuric acid, and has a concentration in the second aqueous solution ranging from 1.0M to 2.5M.
